(19) United States
(12) Patent Application Publication
(10) Pub. No.: US 2013/0038734 A1
(43) Pub. Date: Feb. 14, 2013

(54) DRIVING SUPPORT APPARATUS

(71) Applicant: Kenji FURUKAWA, Fukushima-ken (JP)

(72) Inventor: Kenji FURUKAWA, Fukushima-ken (JP)

(73) Assignee: Toshiba Alpine Automotive Technology Corporation, Iwaki-shi (JP)

(21) Appl. No.: 13/416,592

(22) Filed: Mar. 9, 2012

(30) Foreign Application Priority Data
Aug. 8, 2011 (JP) 2011-172846
Jan. 31, 2012 (JP) 2012-018260

(51) Int. Cl. H04N 7/18

(52) U.S. Cl. 348/148; 348/E07.085

(57) ABSTRACT

According to one embodiment, a driving support apparatus includes a display device, a camera mounted on a vehicle, a vanishing line drawing processing unit that receives image information from the camera and generates a vanishing line by forming a set of vanishing points existing on a plane including the optical axis of the camera, the optical axis of the camera and the running direction of the vehicle being in parallel with each other, a vanishing point being defined as a virtual intersection point located at infinity of the optical axis of the camera and the running direction of the vehicle, and an image processing unit that converts the image information of the camera and the vanishing line into video signals, superimposes one of the video signals on the other and outputs the video signals to the display device.

### CROSS-REFERENCE TO RELATED APPLICATIONS

This application is based upon and claims the benefit of priority from the prior Japanese Patent Applications No. 2011-172846 filed on Aug. 8, 2011 and No. 2012-018260 filed on Jan. 31, 2012, the entire contents of which are incorporated herein by reference.

### FIELD

Embodiments described herein relate generally to a drive support apparatus designed to visually support a driver by means of a vehicle-mounted camera.

### BACKGROUND

There has been proposed driving support designed to improve the sense of distance of a driver by displaying a guide symbol at a position backwardly separated from the driver's own vehicle by a predetermined distance in an image showing a scene surrounding the own vehicle. The guide symbol of such driving support indicates only a distance on a road and is not effective in a situation where the driver is otherwise required to leave the vehicle and visually check the buildings standing along the roadsides.

As for large cargo vehicles such as trailers, rearward visibility support using a camera for shooting the rearward of a driver's own vehicle that provide an image covering the driver's blind spot has been proposed. While such rearward visibility support is useful for checking if there is an obstacle or not in the blind spot of the own vehicle, it is difficult to determine if the own vehicle can move without colliding with the obstacle.

### BRIEF DESCRIPTION OF THE DRAWINGS

FIG. 1 is a schematic plan view of a vehicle (own vehicle) to which a driving support apparatus according to a first embodiment of the present invention is applied, as viewed from right above;

FIG. 2 is a schematic left lateral view of the vehicle (own vehicle) of FIG. 1 as viewed from the driver's seat;

FIG. 3 is a block diagram of the driving support apparatus according to the first embodiment, schematically illustrating the configuration thereof;

FIG. 4 is a schematic illustration of a vanishing point given for the first embodiment;

FIG. 5 is a schematic illustration of vanishing points and a vanishing line;

FIG. 6 is a schematic illustration obtained by superimposing a vanishing line on the monitor screen shown in FIG. 4;

FIG. 7 is an exemplar image where an estimated vehicle trajectory is drawn on a camera-taken image;

FIG. 8 is a flowchart of the process of drawing a vanishing line on the basis of vanishing points;

FIG. 9 is a schematic left lateral view of a vehicle (own vehicle) to which a driving support apparatus according to a second embodiment of the present invention is applied, as viewed from the driver's seat;

FIG. 10 is a schematic illustration obtained by superimposing a vanishing line on an image obtained by a camera;

FIG. 11 is a schematic left lateral view of the vehicle (own vehicle) to which a driving support apparatus according to a third embodiment of the present invention is applied, as viewed from the driver's seat;

FIG. 12 is a rear view of the vehicle of FIG. 11 as viewed from the right side of FIG. 11;

FIG. 13 is a block diagram of the third embodiment of driving support apparatus, schematically illustrating the configuration thereof;

FIG. 14 is an exemplar image picked up by a left forward camera;

FIG. 15 is a schematic illustration of a vanishing line superimposed on the image of FIG. 14 picked up by a left forward camera;

FIG. 16 is a schematic illustration of a vanishing line superimposed on an image picked up by a right forward camera; and

FIG. 17 is a schematic illustration of an exemplar image obtained by superimposing a vanishing line on images picked up by the left and right forward cameras of the fourth embodiment.

### DETAILED DESCRIPTION

According to one embodiment, a driving support apparatus includes a display device, a camera mounted on a vehicle, a vanishing line drawing processing unit that receives image information from the camera and generates a vanishing line by forming a set of vanishing points existing on a plane including the optical axis of the camera, the optical axis of the camera and the running direction of the vehicle being in parallel with each other, a vanishing point being defined as a virtual intersection point located at infinity of the optical axis of the camera and the running direction of the vehicle, and an image processing unit that converts the image information of the camera and the vanishing line into video signals, superimposes one of the video signals on the other and outputs the video signals to the display device.

Now, embodiments of the present invention will be described below by referring to the drawings. Note that, throughout the drawings, the same parts are denoted by the same reference symbols and will not be described repeatedly.

### First Embodiment

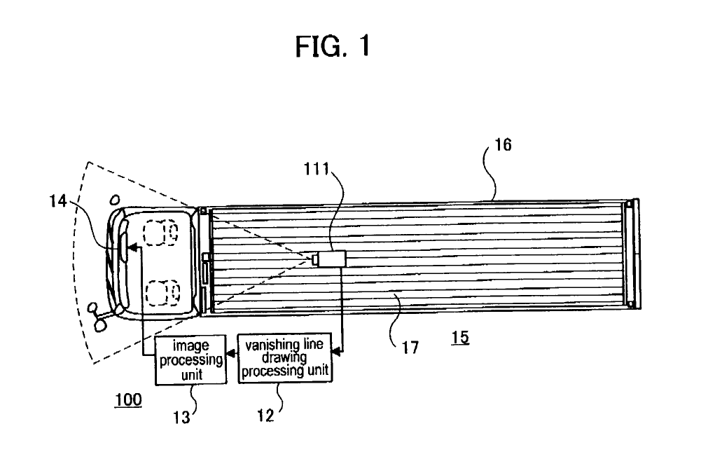

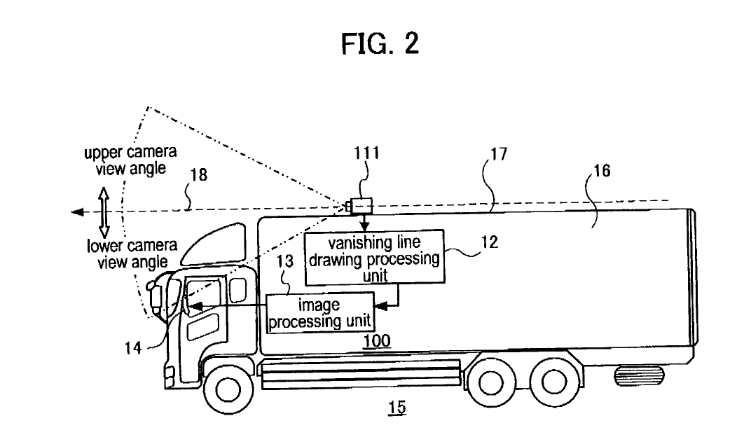

FIG. 1 is a schematic plan view of an own vehicle to which a driving support apparatus according to the first embodiment of the present invention is applied, as viewed from right above. FIG. 2 is a schematic left lateral view of the own vehicle of FIG. 1 as viewed from the side of driver's seat. The vehicle 15 has a loading platform 16 and a roof 17 is formed above the loading platform 16. A monitor 14, which will be described hereinafter, is arranged at a side of the driver's seat.

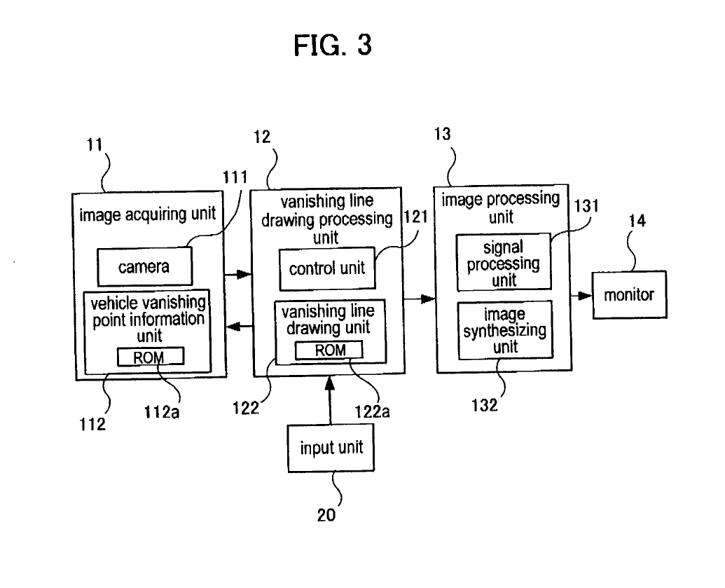

FIG. 3 is a block diagram of the driving support apparatus according to the first embodiment, schematically illustrating the configuration thereof. As shown in FIG. 3, the driving support apparatus 100 includes an image acquiring unit 11, a vanishing line drawing processing unit 12, an image processing unit 13 and a monitor 14. The monitor 14 may be dedicated to the driving support apparatus 100 or made to operate also as a display for some other device(s). An input unit 20 for receiving operations and directives for the driving support apparatus 100 from the driver is connected to the vanishing line drawing processing unit 12.

The image acquiring unit 11 includes a camera 111 and a vehicle vanishing point information unit 112.

The camera 111 is arranged on the roof 17 at a position located substantially on the center line between the lateral sides of the vehicle and close to the front end (as viewed in the forward moving direction) of the loading platform 16. The optical system of the camera 111 is directed to the running direction (the forward moving direction) of the vehicle 15 in such away that the optical axis 18 thereof runs substantially in parallel with the surface of the road on which the vehicle runs. The camera 111 may typically be a fixed focus lens type and includes an image pickup device such as a CCD (charge coupled device) or a CMOS (complementary metal oxide semiconductor) image sensor. The range in the horizontal direction that the camera 111 can shoot is, for example, the region indicated by broken lines in FIG. 1. The range in the vertical direction that the camera 111 can shoot is, for example, the region indicated by broken lines in FIG. 2. In FIG. 2 and other similar drawings, the camera image upper section and the camera image lower section in the camera image picked up by the camera correspond respectively to the upper section and the lower section in the three-dimensional space shot by the camera.

The vehicle vanishing point information unit 112 stores data on the vanishing points (which will be described hereinafter) that are acquired in advance on the basis of fitting information of the camera 111 relative to the vehicle 15. Camera fitting information typically includes information on the fitting position, the fitting height and the inclination of the camera.

Now, a vanishing point will be described below. While two straight lines intersect each other at a point on a plane, two parallel straight lines do not intersect each other. In projective geometry, however, two parallel straight lines are assumed to intersect each other at infinity and the intersection point is referred to as point at infinity. A projected image of a point at infinity is a vanishing point. Two parallel straight lines intersect each other at a point at infinity regardless of their direction and all points at infinity are assumed to be on a virtual straight line, which is referred to as a line at infinity.

The above description will now be examined from the viewpoint of a running vehicle. A vehicle running oppositely relative to the own vehicle can be regarded as a vehicle appearing from a vanishing point existing on the horizon far way on the road on which the own vehicle is running, whereas the own vehicle is running toward the vanishing point. When attention is paid to the edge lines of the road, the point to which the edge lines converge will be detected as a vanishing point.

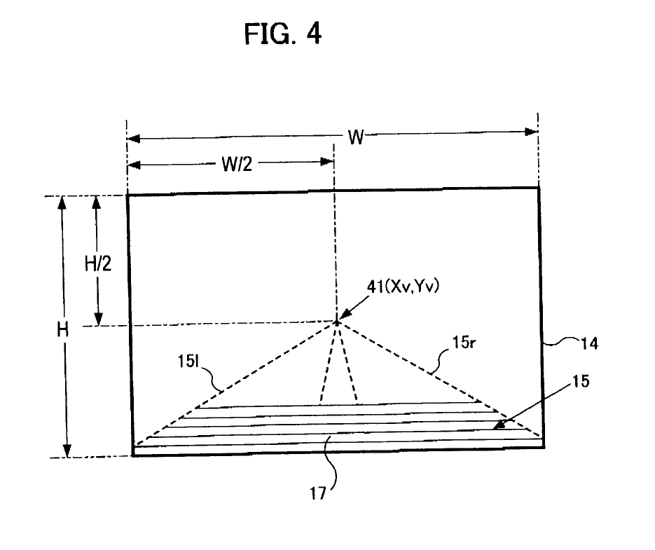

FIG. 4 is a schematic illustration of a vanishing point given for the first embodiment. FIG. 4 shows an instance where a vanishing point is projected on an image displayed on the monitor 14 having a display area of height H and width W. As described above, the camera 111 is arranged with its optical axis 18 running substantially in parallel with the surface of the road. Therefore, straight lines running in parallel with the optical axis 18 such as a straight line indicating the running direction of the vehicle and extensions of the line segments defining the lateral extremities, or the width, of the vehicle intersect each other at a point at infinity to form a vanishing point. In FIG. 4, a vanishing point 41 is displayed at the center of the display area of the monitor 14. In FIG. 4, X indicates the horizontal direction and Y indicates the vertical direction. Thus, the vanishing point 41 can be expressed by position data of two-dimensional coordinates (Xv, Yv) to obtain an equation of vanishing point (Xv, Yv)=(W/2, H/2).

In the following description, the above position data of the two-dimensional coordinates is employed as vanishing point 41.

The straight line 15r indicating the right lateral extremity of the vehicle 15 and the straight line 15l indicating the left lateral extremity of the vehicle 15 are displayed in FIG. 4 and the straight lines 15l, 15r intersect each other at vanishing point (Xv, Yv) 41. Information on the acquired vanishing point 41 is stored typically in the ROM (read only memory) 112a of the vehicle vanishing point information unit 112 so that the information can be read out whenever necessary.

The image signals acquired by the camera 111 and the vanishing point information read out from the ROM 112a of the vehicle vanishing point information unit 112 are supplied to the vanishing line drawing processing unit 12 on the next stage.

The vanishing line drawing processing unit 12 includes a control unit 121 that generates a control signal for generating a vanishing line (which will be described hereinafter) upon receiving an instruction from the input unit 20 and a vanishing line drawing unit 122 for generating drawing data of the vanishing line. The mode of input of the input unit 20 may be that of key input, that of touch panel input using the keys displayed on the display screen of the monitor 14 or that of voice input.

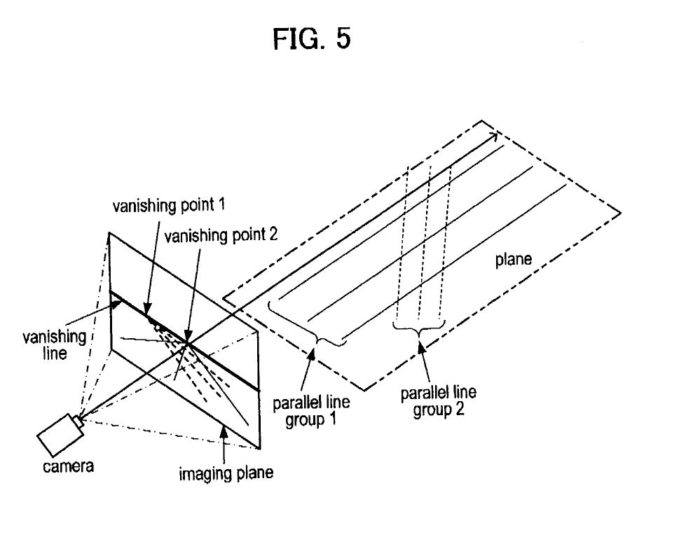

FIG. 5 is a schematic illustration of vanishing points and a vanishing line. As shown in FIG. 5, there are an infinite number of vanishing points as many as parallel line group 1, parallel line group 2, . . . that exist on a plane where the optical axis 18 of the camera 111 lies. Note, however, if these parallel line groups are found on a same plane, all the vanishing points are aligned on a straight line on the plane, which straight line is referred to as vanishing line. The vanishing line is the line of convergence at infinity on the plane where the optical axis 18 of the camera 111 lies. That is, the vanishing line is the line of convergence when the plane where the optical axis 18 lies extends in infinite direction. The vanishing line can be displayed as a virtual straight line on the image picked up by the camera.

Since the camera 111 is mounted on the roof 17 of the vehicle 15, the vanishing line operates as guide line for determining if an obstacle relative to the vehicle can collide with the own vehicle depending on if the obstacle is located below or above the vanishing line.

For the purpose of simplicity of explanation, in this embodiment, it is assumed that the optical axis 18 of the camera 111 runs in parallel with the extension lines defining the lateral extremities of the vehicle and the vehicle 15 runs in parallel with the surface of the road. When an image picked up by the camera 111 is displayed on the monitor screen, the vanishing point 41 is located at the center of the monitor screen and the vanishing line is a horizontal line segment that includes the vanishing point 41 on the monitor screen (to be referred to as horizontal vanishing line hereinafter) (see FIGS. 4 and 5). Similarly, the vertical line segment that includes the vanishing point 41 is referred to as vertical vanishing line hereinafter.

Now, the equation expressing the horizontal vanishing line drawn on the basis of the vanishing point (Xv, Yv)=(W/2, H/2) will be described below. An equation expressing straight lines on the coordinate plane of aX+bY+c=0 is provided here so that it may express a group of straight lines running in parallel with the Y-axis.

Since vanishing points (W/2, H/2) exist on the vanishing line, the coefficients in the above equation are (a, b, c)=(0, 1, −H/2).

The control unit 121 reads out the vanishing point 41 stored in the ROM 112a of the vehicle vanishing point information unit 112 and supplies it to the vanishing line drawing unit 122. The control unit 121 controls the vanishing line drawing unit 122 to generate data for drawing the horizontal vanishing line expressed by the above straight line equation that is the horizontal line segment including the vanishing point 41.

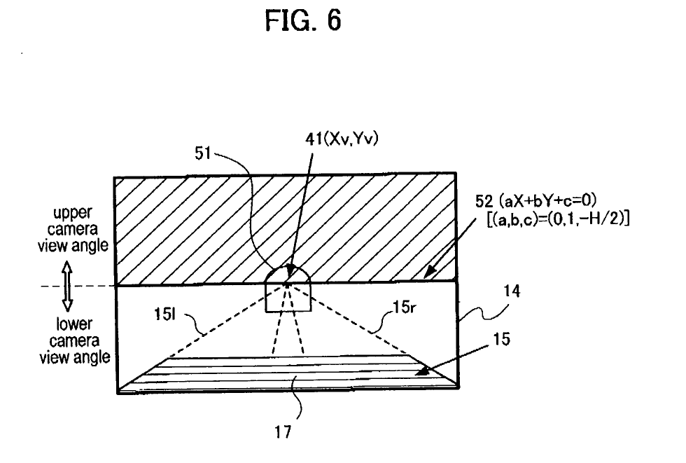

FIG. 6 is a schematic illustration obtained by superimposing a vanishing line 52 on the monitor screen shown in FIG. 4. The vanishing line 52 may suitably be colored or drawn as a special line so that the driver of the own vehicle can recognize with ease the line that is being displayed on the monitor screen. For this purpose, data on different colors and different lines (line types: solid line, broken line, widths thereof) are stored in advance in the ROM 122a of the vanishing line drawing unit 122.

A tunnel 51 is shown far ahead of the own vehicle on the monitor screen illustrated in FIG. 6. The relationship between the own vehicle and the tunnel 51 will be described hereinafter.

The image processing unit 13 includes a signal processing unit 131 and an image synthesizing unit 132. The signal processing unit 131 converts the analog video signal from the camera 111 into a digital video signal and executes video signal processing on the digital video signal in order to display an image on the monitor 14. Additionally, the signal processing unit 131 receives the vanishing line data and the line type information produced from the vanishing line processing unit 12 and generates a video signal for causing the monitor 14 to display a horizontal vanishing line 52 with a desired color and a desired width. The image synthesizing unit 132 executes an image synthesizing process on the basis of the two video signals generated by the signal processing unit 131 and causes the monitor 14 to display an image as shown in FIG. 6. Since the vanishing line is a virtual line, the driver may not necessarily comfortably see the image picked up by the camera if the vanishing line is constantly superimposed on the image picked up by the camera. Therefore, it may be suitable that the vanishing line is superimposed on the image picked up by the camera only for the time period specified by the driver by way of the input unit 20.

The image synthesizing unit 132 may be so adapted as to display a laterally reversed image on the monitor 14 when the camera 111 is turned to the rearward moving direction of the own vehicle.

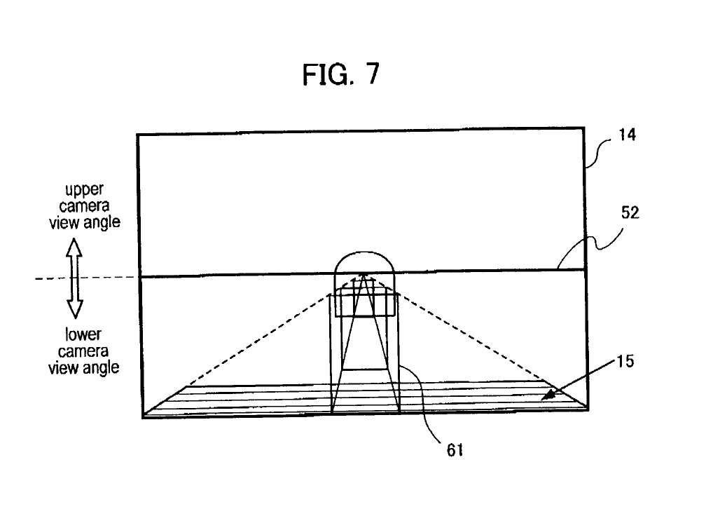

FIG. 7 is an exemplar image where an estimated vehicle trajectory of a running vehicle is displayed on a camera-taken image. Thus, the image acquiring unit 11 may be equipped with a functional feature of storing an estimated vehicle trajectory 61 of the running own vehicle, reading it out when necessary, synthetically combining it with a camera-taken image and displaying the combined image on the monitor screen.

When a plurality of cameras is mounted on a vehicle, the image synthesizing unit 132 may be made to display all the images picked up by the cameras simultaneously side by side on the single screen of the monitor 14. When a camera facing the front-moving direction and a camera facing the rearward moving direction of a vehicle are mounted, the image synthesizing unit 132 may be made to cooperate with the shift lever position and display only the image picked up by the camera facing the direction in which the vehicle is actually moving on one or more monitor screens.

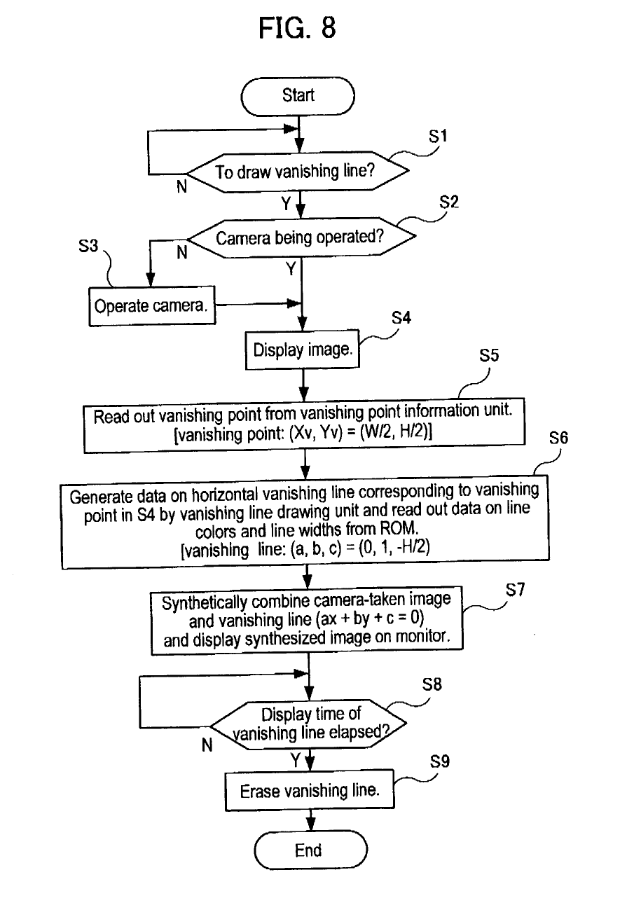

Now, an exemplar process of drawing a vanishing line of a driving support apparatus 100 having the above-described configuration will be described below. FIG. 8 is a flowchart of the process of drawing a vanishing line on the basis of vanishing points.

Firstly, the control unit 121 determines if an instruction for drawing a vanishing line is input to the input unit 20 or not (Step S1). When it is determined that an instruction for drawing a vanishing line is input, the control unit 121 then determines if the camera 111 is operating or not (Step S2). If the camera 111 is operating (Yes in Step S2), the image picked up by the camera 111 is sent to the image processing unit 13, which generates a video signal and sends the generated video signal to the monitor 14 so as to have the latter display the image (Step S4).

If, on the other hand, it is determined that the camera 111 is not operating (No in Step S2), the control unit 12 starts the camera 111 to operate (Step S3) and then proceeds to Step S4.

Then, the control unit 121 reads out the data [(Xv, Yv)=(W/2, H/2)] on the vanishing point 91 from the vehicle vanishing point information unit 112 (Step S5).

Thereafter, the control unit 121 controls the vanishing line drawing unit 122 and generates data [(a, b, c)=(0, 1, −H/2)] on the horizontal vanishing line 52 expressed by straight line (aX+bY+c=0) on the basis of vanishing points (Xv, Yv). The control unit 121 also reads out the data on colors and line widths stored in the ROM 122a.

Then, the control unit 121 synthetically combines the camera-taken image with the vanishing line [(aX+bY+c=0)] 52 and displays the combined image on the monitor (Step S7).

The control unit 121 determines if the drawing time of the horizontal vanishing line 52 has exceeded a predetermined time period, e.g., 30 seconds (Step S8) and, if the drawing time has exceeded the predetermined time period, it erases the horizontal vanishing line 52 from the monitor 14 (Step S9).

It may alternatively be so arranged that the control unit 121 does not erase the horizontal vanishing line 52 unless an erase instruction is input to the input unit 20.

Now, that a vanishing line as described above can effectively be used in a situation where a vehicle can avoid collisions with obstacles will be described below.

As an example, assume that there is a tunnel 51 ahead in the running direction of the vehicle 15 and let us discuss a determination if the vehicle 15 can pass through the tunnel 51 or not below (see FIG. 6).

Firstly, the camera 111 is driven to operate and the image picked up by the camera 111 is displayed on the monitor 14. If the vehicle can pass through the tunnel 51 displayed on the monitor 14 or not is a delicate issue to be determined, the driver has the driving support apparatus draw the horizontal vanishing line 52 by means of the input unit 20. Since the horizontal vanishing line 52 is virtually produced so as to include the optical axis of the camera 111 on the roof 17, any object located above the point of installation of the camera 111 is displayed above the horizontal vanishing line 52. By the same token, any object located below the point of installation of the camera 111 is displayed below the horizontal vanishing line 52.

Thus, the driver can determine if the vehicle can pass through the tunnel 51 or not by seeing if the horizontal vanishing line 52 being displayed on the monitor 14 is found above or below the height of the tunnel 51.

When the vehicle is to be driven rearward and it is necessary to determine if the vehicle can pass by any obstacle located rearward or not, it is only necessary to turn the camera 111 to face rearward and follow the above-described process for a determination on monitor 19.

The vanishing line drawing processing unit 12 may alternatively be made to have the functional feature of the vehicle vanishing point information unit 112.

Thus, with this embodiment, even in a situation where a vehicle is located very close to a building or some other obstacle in terms of distance or height and hence it is difficult for the driver to determine if the vehicle can safely pass by, the driver can visually determine at a glance in the inside of the vehicle if the vehicle can hit or collide with the obstacle or not without leaving the vehicle and visually checking the obstacle.

### Second Embodiment

Now, the second embodiment of the present invention will be described below.

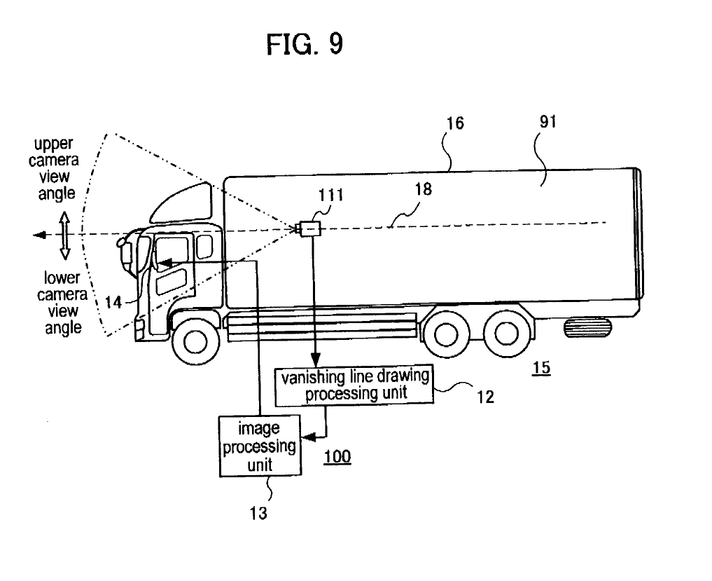

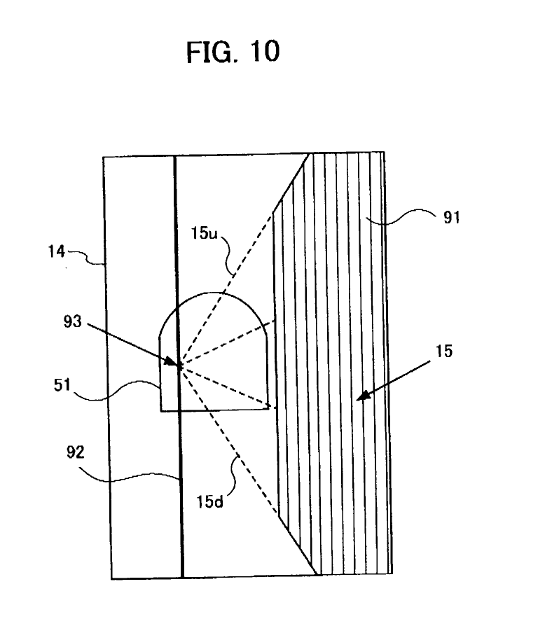

FIG. 9 is a schematic left lateral view of a vehicle (own vehicle) to which a driving support apparatus according to the second embodiment is applied, as viewed from the driver's seat. FIG. 10 is a schematic illustration obtained by superimposing a vanishing line on an image obtained by a camera. In the second embodiment, the camera 111 is arranged at the left lateral surface 91 of the loading platform 16 as shown in FIG. 9. It is difficult for the driver of a vehicle having the steering wheel arranged at the right side to determine if the vehicle can pass by an obstacle found at the left side of the vehicle body or not. Therefore, an image picked up by the camera arranged at the left lateral surface 91 of the vehicle is displayed on the monitor and a vertical vanishing line 92 is drawn on the image as shown in FIG. 10.

As shown in FIG. 10, extension lines 15u, 15d of the top line and the bottom line of the left lateral surface 91 of the vehicle 15 intersect each other at infinity to form a vanishing point 93. The line of convergence at infinity on the vertical plane where the optical axis 18 of the camera lies is drawn as vertical vanishing line 92. The signal processing unit 131 receives the vanishing line data and the line type information produced from the vanishing line processing unit 12 and generates a video signal for causing the monitor 14 to display a vertical vanishing line 92 with a desired color and a desired width. The image synthesizing unit 132 executes an image synthesizing process on the basis of the video signals generated by the signal processing unit 131 and causes the monitor 14 to display an image as shown in FIG. 10.

with the second embodiment, when there is a tunnel 51 ahead in the running direction of the own vehicle, an image of the tunnel 51 and a vertical vanishing line 92 are displayed on the monitor 14 as shown in FIG. 10. In such a situation, it is possible to determine if the vehicle 15 can pass through the tunnel 51 from the viewpoint of the width of the tunnel 51 by seeing if the vertical vanishing line 92 drawn on the monitor 14 is found inside or outside of the tunnel 51.

When the vehicle is to be driven rearward and it is necessary to determine if the vehicle can pass by any obstacle located rearward or not, it is only necessary to turn the camera 111 to face rearward and follow the above-described process for a determination on monitor 14.

Thus, with this embodiment of which the camera is arranged at a lateral side of the vehicle, even in a situation where the width of a structure is very close to the width of the vehicle and hence it is difficult to determine if the vehicle can safely pass by without hitting the structure or not, the driver can visually determine at a glance in the inside of the vehicle if the vehicle can hit or collide with the structure without leaving the vehicle and visually checking the structure.

### Third Embodiment

Now, the third embodiment of the present invention will be described below.

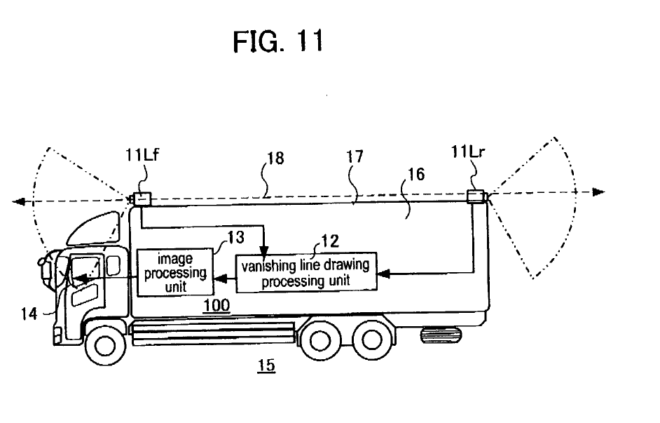

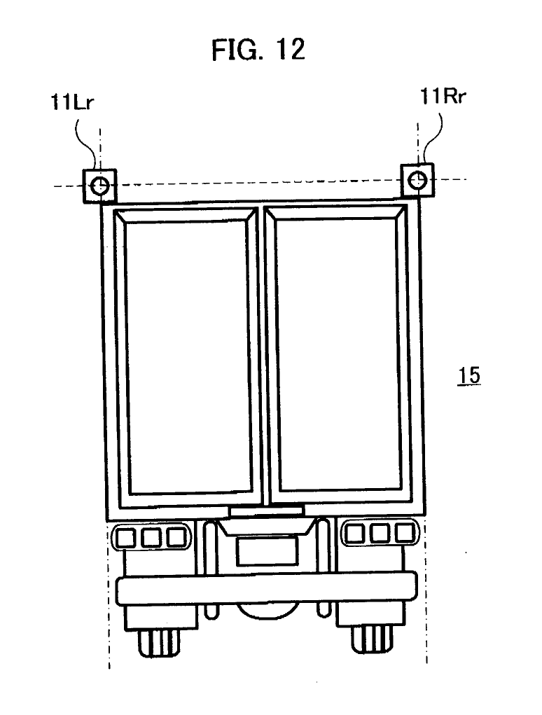

FIG. 11 is a schematic left lateral view of a vehicle (own vehicle) to which a driving support apparatus according to the third embodiment is applied, as viewed from the driver's seat. FIG. 12 is a rear view of the vehicle.

With the third embodiment, left cameras and right cameras are arranged on the roof 17 of the loading platform 16 of the vehicle 15 as shown in FIGS. 11 and 12. A left forward camera 11Lf and a right forward camera 11Rf (not shown in FIG. 11) are arranged at the front end of the roof. A left rearward camera 11Lr and a right rearward camera 11Rr are arranged at the rear end of the roof.

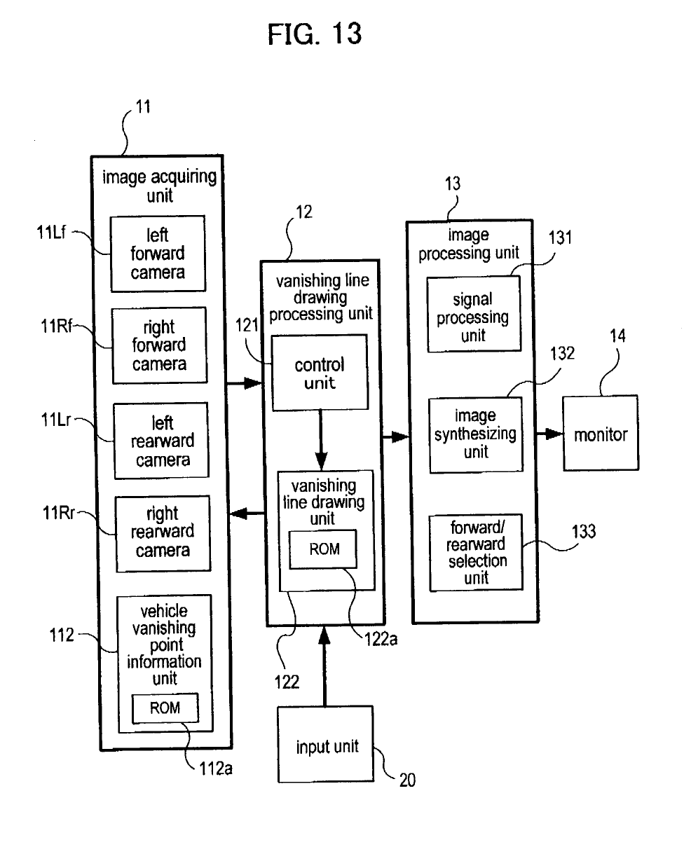

FIG. 13 is a block diagram of the driving support apparatus according to the third embodiment, schematically illustrating the configuration thereof. The driving support apparatus 200 of the third embodiment includes an image acquiring unit 21, a vanishing line drawing processing unit 12, an image processing unit 23 and a monitor 14.

The image acquiring unit 21 includes the left forward camera 11Lf, the right forward camera 11Rf, the left rearward camera 11Lr, the right rearward camera 11Rr and a vehicle vanishing point information unit 112.

The image processing unit 23 has a laterally reversing function of laterally reversing the image picked up by the left rearward camera 11Lr and also the image picked up by the right forward camera 11Rf. While the cameras themselves may be provided with such a function, a single common camera can be used as a forward camera and another single common camera can be used as a rearward camera when the function is provided outside the cameras. The image processing unit 23 has a forward/rearward selection unit 133 for selectively taking out the output of a desired camera out of the plurality of cameras.

Now, the process of generating a vanishing line by the vanishing line drawing unit 122 and superimposing the vanishing line on each of the images picked up by the left and right forward cameras 11Lf, 11Rf by the image synthesizing unit 132 of the image processing unit 23 will be described below. A vanishing line drawing operation is also conducted for the left and right rearward cameras 11Lr, 11Rr, although it will not be described any further.

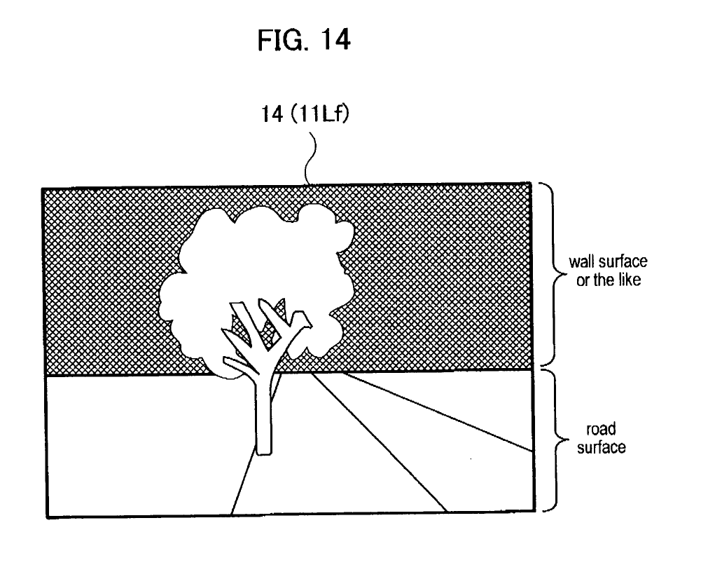

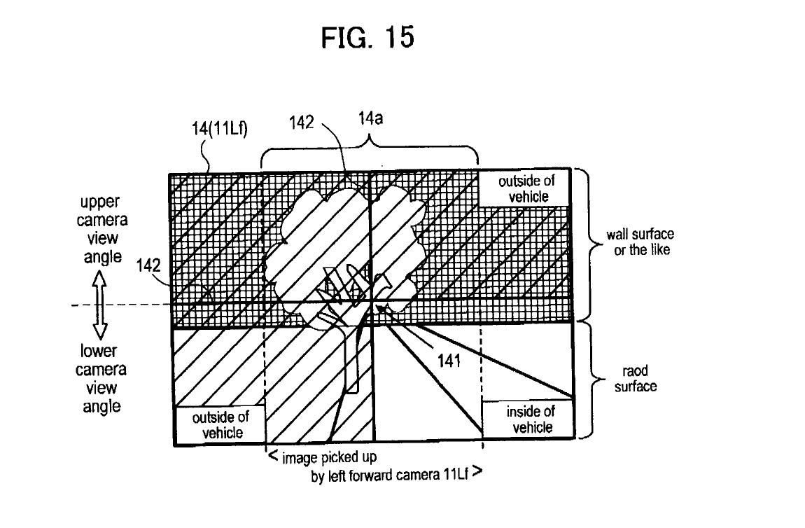

FIG. 14 is an exemplar image picked up by the left forward camera 11Lf. FIG. 15 is a schematic illustration of a vanishing line superimposed on the image of FIG. 14 picked up by a left forward camera 11Lf.

When the driver operates the input unit 20 and turns on the left forward camera 11Lf, the image picked up by the camera 11Lf is displayed on the monitor 14 as shown in FIG. 14. Lines are drawn for two lanes on the road shown in FIG. 14. A roadside tree is shown on the left side of the road and a wall is shown behind the roadside tree. In the image shown in FIG. 15, the area shaded by oblique lines shows the outside of the vehicle. Since a camera is fitted to a lateral surface or the top surface of the vehicle and hence located very close to the latter, the horizontal vanishing line 142 and the vertical vanishing line 143 indicate the boundaries between the inside and the outside of the vehicle.

Assume, here, that an instruction of drawing a vanishing line is input to the control unit 121 by way of the input unit 20. Then, the control unit 121 controls the vanishing line drawing unit 122 and has the latter generate data on a horizontal vanishing line 192 obtained by extending a horizontal line segment that includes vanishing point 191 (see FIG. 15). The control unit 121 further controls the vanishing line drawing unit 122 and has the latter generate data on a vertical vanishing line 143 obtained by extending a vertical line segment that includes vanishing point 141. The color and the type of the horizontal vanishing line 142 and those of the vertical vanishing line 143 are read out from the ROM 122a of the vanishing line drawing unit 122 that stores these data in advance.

The signal processing unit 131 generates a video signal representing the horizontal vanishing line 142 from the data on the horizontal vanishing line generated by the vanishing line drawing unit 122 and also a video signal representing the vertical vanishing line 143 from the data on the vertical vanishing line generated by the vanishing line drawing unit 122.

The image synthesizing unit 132 executes a process of synthetically combining the image obtained by the left forward camera 11Lf, the horizontal vanishing line 142 and the vertical vanishing line 143 and outputs the outcome of the synthesis to the monitor 14. Then, the image that is synthetically combined with the horizontal vanishing line 142 and the vertical vanishing line 143 is displayed on the monitor 14 (see FIG. 15).

In the case of the image picked up by the left forward camera 11Lf shown in FIG. 15, there is a tree that can obstruct the passage of the vehicle at the left side of the vertical vanishing line 143 and one of the branches of the tree extends below the horizontal vanishing line 142. Thus, the image tells that the vehicle hits the branch if it keeps on moving straight.

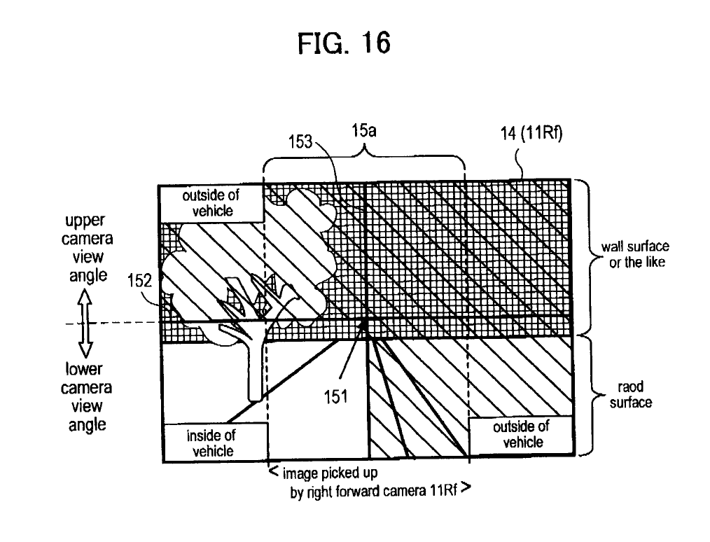

Similarly, when the right forward camera 11Rf is turned on, an image picked up at a shooting angle different from that of the image of FIG. 15 picked up by the left forward camera 11Lf is displayed on the monitor 14. FIG. 16 is a schematic illustration of a vanishing line superimposed on the image picked up by the right forward camera 11Rf. Then, the control unit 121 controls the vanishing line drawing unit 122 and has the latter generate data on a horizontal vanishing line 152 obtained by extending a horizontal line segment that includes vanishing point 151 (see FIG. 16). The control unit 121 further controls the vanishing line drawing unit 122 and has the latter generate data on a vertical vanishing line 153 obtained by extending a vertical line segment that includes vanishing point 151. The vertical vanishing line 153 runs in parallel with the lateral surface of the vehicle far from the driver (steering wheel arranged at the right side).

The color and the type of the horizontal vanishing line 152 and those of the vertical vanishing line 153 are read out from the ROM 122a of the vanishing line drawing unit 122 that stores these data in advance.

The signal processing unit 131 generates a video signal representing the horizontal vanishing line 152 from the data on the horizontal vanishing line generated by the vanishing line drawing unit 122 and also a video signal representing the vertical vanishing line 153 from the data on the vertical vanishing line generated by the vanishing line drawing unit 122.

The image synthesizing unit 132 executes a process of synthetically combining the image obtained by the right forward camera 11Rf, the horizontal vanishing line 152 and the vertical vanishing line 153 and outputs the outcome of the synthesis to the monitor 14. Then, the image that is synthetically combined with the horizontal vanishing line 152 and the vertical vanishing line 153 is displayed on the monitor 14 (see FIG. 16).

In the case of the image picked up by the right forward camera 11Rf shown in FIG. 16, there is not any obstacle such a tree that can obstruct the passage of the vehicle at the right side of the vertical vanishing line 153. In other words, the image tells that no problem arises if the vehicle keeps on moving straight.

The hatching in each of FIGS. 15 and 16 that shows the space where the vehicle 15 cannot pass through may be actually displayed on the monitor 14. However, it is omitted in this embodiment from an aesthetic viewpoint.

While each of the left forward camera 11Lf and the right forward camera 11Rf is turned on by way of an operation at the input unit 20 in the above description, it may alternatively be so arranged that all the cameras including the left and right forward cameras 11Lf and 11Rf and the left and right rearward cameras 11Lr and 11Rr are constantly held in an on state and the output of a desired one of the cameras is taken out by means of the forward/rearward selection unit 133 of the image processing unit 13.

Still alternatively, it may be so arranged that all the cameras including the left and right forward cameras 11Lf and 11Rf and the left and right rearward cameras 11Lr and 11Rr are constantly held in an on state and the horizontal vanishing line 142 and the vertical vanishing line 143 may be superimposed on all the images picked up by the left and right forward and rearward cameras and arranged at respective positions on the monitor 14 that correspond to the cameras. Still alternatively, it may be so arranged that the images picked up by the left and right forward and rearward cameras are sequentially displayed on the monitor 14 in response to switch operations and the horizontal vanishing line 142 and the vertical vanishing line 143 are superimposed on the image that is being displayed.

Thus, with this embodiment, infinite lines extending from the lateral surfaces and the top surface of an own vehicle are displayed on a monitor screen to make it possible to determine if the own vehicle can safely pass by a branch projecting low on the road on which the vehicle is running. Thus, even in a situation where a vehicle is located very close to a building or some other obstacle and hence it may be difficult for the vehicle to safely pass by, the driver can visually determine at a glance in the inside of the vehicle if the vehicle can hit or collide with the obstacle or not without leaving the vehicle and visually checking the obstacle.

### Fourth Embodiment

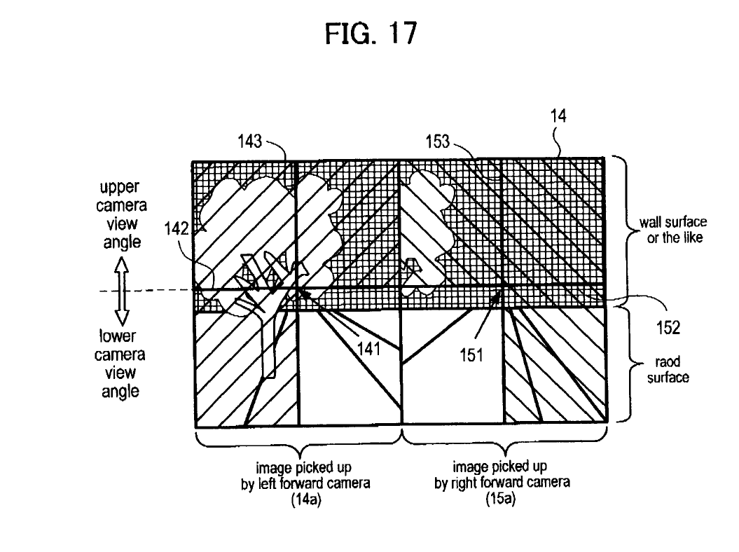

Now, the fourth embodiment of the present invention will be described below. The fourth embodiment is basically same as the third embodiment in terms of configuration. FIG. 17 is a schematic illustration of an exemplar image obtained by superimposing a vanishing line on images picked up by the left and right forward cameras of the fourth embodiment. The fourth embodiment synthetically combines the images picked up by the left and right cameras. In other words, the region 14a of the entire image picked up by the left forward camera 11Lf as shown in FIG. 15 and the region 15a of the entire image picked up by the right forward camera 11Rf as shown in FIG. 16 are synthetically combined by the image synthesizing unit 132 and the synthetically combined image is displayed on the monitor 14.

Thus, the left half of the monitor 14 displays an image formed on the basis of the image picked up by the left forward camera 11Lf, on which horizontal vanishing line 142 that is an extension of a horizontal line segment including vanishing point 141 and vertical vanishing line 143 that is an extension of a vertical line segment including vanishing point 141 are drawn.

On the other hand, the right half of the monitor 14 displays an image formed on the basis of the image picked up by the right forward camera 11Rf, on which horizontal vanishing line 152 that is an extension of a horizontal line segment including vanishing point 151 and vertical vanishing line 153 that is an extension of a vertical line segment including vanishing point 151 are drawn.

With this arrangement, the driver can check if the own vehicle can safely pass by the left and right forward obstacles (if any) by means of the synthetically combined image that is being displayed on the monitor 14.

The driver can also obtain support for determining if the own vehicle can safely pass by the obstacles (if any) with regard to the rearward of the vehicle by selecting the left and right rearward cameras 11Lr and 11Rr by means of the forward/rearward selection unit 133. Alternatively, it may be so arranged that the monitor 14 displays the images obtained by the left and right forward cameras 11Lf and 11Rf on an upper half of the monitor screen and the images obtained by the left and right rearward cameras 11Lr and 11Rr on a lower half of the monitor screen.

This embodiment can display both horizontal vanishing lines and vertical vanishing lines simultaneously for the two lateral sides of a vehicle. Thus, the driver of a vehicle can determine if the own vehicle can safely pass by the obstacles, if any, or not regardless if the vehicle is moving forward or rearward. This embodiment is particularly effective for heavy trailers.

### Fifth Embodiment

Now, the fifth embodiment of the present invention will be described below.

The coordinates of a vanishing point that is displayed on the monitor are (xv, Yv)=(W/2, H/2) for the first through fourth embodiments. In other words, it is a vanishing point in a state where a camera 111 having a fixed focal lens is fitted onto the roof 17 or to a lateral surface 91 of a vehicle 15 with the optical axis 18 of the camera running in parallel with the road surface.

On the other hand, the fifth embodiment is designed to obtain a vanishing point by a camera 111 having a fixed focal lens with the optical axis 18 of the camera inclined downward by 5° from a horizontal plane. As the shooting angle of the camera 111 is inclined downward, the coordinates of the vanishing point are shifted downward to compensate the angle of inclination. Then, the position of the vanishing point can be shifted by selecting a value that corresponds to the angle shift for c in the equation aX+bY+c=0 for vanishing lines.

Thus, when the optical axis of the camera is inclined downward by 5°, the distance between a own vehicle 15 and an obstacle is increased in an image picked up by the camera to make the driver capable of easily grasping the positional relationship between the own vehicle 15 and the obstacle and hence determining if the vehicle can safely pass by the obstacle or not with ease.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A driving support apparatus comprising:
a display device;
a camera mounted on a vehicle;
a vanishing line drawing processing unit that receives image information from the camera and generates a vanishing line by forming a set of vanishing points existing on a plane including the optical axis of the camera, the optical axis of the camera and the running direction of the vehicle being in parallel with each other, a vanishing point being defined as a virtual intersection point located at infinity of the optical axis of the camera and the running direction of the vehicle; and
an image processing unit that converts the image information of the camera and the vanishing line into video signals, superimposes one of the video signals on the other and outputs the video signals to the display device.

2. The apparatus according to claim 1, further comprising a vehicle vanishing point information unit that stores in advance, as position data of the two-dimensional coordinates, the vanishing point generated on the basis of the image information of the camera.

3. The apparatus according to claim 1, wherein the vanishing line drawing processing unit stores in advance data on different colors and different line types that can selectively be used for displaying the vanishing line on images to be displayed on the display device.

4. The apparatus according to claim 1, wherein the vanishing line drawing processing unit generates data on a horizontal vanishing line that is an extension of a horizontal line segment including the vanishing point.

5. The apparatus according to claim 1, wherein the camera has a fixed focal lens and is formed by using an image pickup device such as a CCD (charge coupled device) or a CMOS (complementary metal oxide semiconductor).

6. The apparatus according to claim 1, wherein the camera is mounted so as to face the forward moving direction or the rearward moving direction of the vehicle.

7. The apparatus according to claim 1, wherein the camera is mounted on the roof of the vehicle at a position located substantially on the center line between the lateral sides of the vehicle.

8. The apparatus according to claim 1, wherein the camera is mounted at a position on the left lateral surface or the right lateral surface of the vehicle and another camera is mounted at a position on the other lateral surface of the vehicle or the camera is mounted at a position either on the left lateral surface or on the right lateral surface of the vehicle.

9. The apparatus according to claim 1, wherein the vanishing line drawing processing unit generates data on a vertical vanishing line that is an extension of a vertical line segment including the vanishing point.

10. The apparatus according to claim 1, wherein the camera is mounted at the front side of the roof of the vehicle as left forward camera and another camera is mounted at the front side of the roof of the vehicle as right forward camera, while other two cameras are mounted at the rear side of the roof of the vehicle as left and right rearward cameras.

11. The apparatus according to claim 10, wherein the image processing unit has a functional feature of laterally reversing the image picked up by the left rearward camera and also the image picked up by the right forward camera.

12. The apparatus according to claim 10, wherein the image processing unit has a forward/rearward selection unit that selectively takes out the output of a specific camera out of the plurality of cameras.

13. The apparatus according to claim 10, wherein the images picked up by all the cameras are displayed on the screen of the display device at positions corresponding to the respective camera positions with a horizontal vanishing line and a vertical vanishing line superimposed on each of them.

14. The apparatus according to claim 13, wherein the superimposed display of the horizontal vanishing line or the vertical vanishing line is on/off controllable.

15. The apparatus according to claim 1, wherein a camera facing the forward moving direction of the vehicle and a camera facing the rearward moving direction of the vehicle are mounted and only the image picked up by the camera facing the moving direction defined by the vehicle shift lever position is displayed on the screen of the display device.

16. The apparatus according to claim 1, wherein the camera is mounted with its optical axis inclined downward from a horizontal plane.
